(19) United States
(12) Patent Application Publication
(10) Pub. No.: US 2014/0375423 A1
(43) Pub. Date: Dec. 25, 2014

(54) PORTABLE AUTHENTICATION MEANS AND VEHICLE SECURITY SYSTEM FOR A MOTOR VEHICLE

(71) Applicant: Johnson Controls Automotive Electrnics SAS, Cergy Pontoise Cedex (FR)

(72) Inventor: Gregoire Lagabe, Paris (FR)

(73) Assignee: Johnson Controls Automotive Electrnics SAS, Cergy Pontoise Cedex (FR)

(21) Appl. No.: 14/374,609

(22) PCT Filed: Jan. 22, 2013
(86) PCT No.: PCT/EP2013/051120

§ 371 Date: Jul. 25, 2014

(30) Foreign Application Priority Data
Jan. 26, 2012 (DE) 10-2012-001442.2
May 3, 2012 (FR) 12/01294

(51) Int. Cl. G07C 9/00

(52) U.S. Cl. CPC G07C 9/00182; G07C 2009/00206
USPC 340/5.61

(57) ABSTRACT

A portable authentication apparatus, in particular for use with a motor vehicle, includes a transmission unit and a receiving unit for the wireless transmission of signals between the authentication apparatus and a control apparatus which is built into the motor vehicle and which is intended for controlling the authorization of access and/or the authorization of use for the motor vehicle. The authentication apparatus further has an encoding and decoding unit for decoding the received signals and for encoding the transmitted signals. The authentication apparatus includes an inertial detector and/or a motion detector.

The present invention relates to a portable authentication means and a vehicle security system for a motor vehicle.

From the prior art, for example from document EP 0 984 123 B1, access and use authorization systems for motor vehicles are known which do not require a conventional key.

Vehicle security systems of this type are often referred to as “keyless”. Here, the user of a vehicle receives a portable authentication means, without handling operations, which is simply carried by the user and is associated with his vehicle. When the user looks for his vehicle and thus brings the authentication means into the operational area of a control system built into the motor vehicle, an access authorization control mechanism is activated without the user having to control it manually. The access authorization control mechanism is based on a wireless signal transmission between the motor vehicle and the control system. It then suffices for the user to carry the authentication means on his person, for example in a pocket or in a bag. With the access authorization control mechanism, an encoded signal is, for example, then sent from the control system to the authentication means, and the authentication means decodes this signal and returns it with a new code. The two codes are stored in the control apparatus on-board the vehicle in such a way that the control apparatus can carry out a comparison of the actual coded signal with the signal immediately received from the authentication means. If the codes match, an authentication is carried out and the motor vehicle door locks are automatically unlocked in such a way that the user has access to the motor vehicle without having to open the motor vehicle for that purpose via a manual opening operation. lf, on the other hand, the codes do not match, the motor vehicle remains locked so that no unauthorized person can have access to the motor vehicle. So that the motor vehicle can be unlocked only when the user actually wishes to be able to access the vehicle, the on-board control apparatus is coupled to on-board antennas which have a very short transmit range. When the user carrying the authentication means moves further away from the vehicle, no unlocking takes place. In the same way, the vehicle immobilizer is controlled in such a way that the user carrying the authentication means can cause the engine to start by means of a simple switch and the immobilizer is deactivated when it is detected that the “correct” authentication means is located, for example, inside the vehicle. To increase security, it is furthermore known, for example from document EP 1 033 585 A2, for the distance separating the authentication means and the vehicle to be determined by means of transit time measurements.

A problem with such access and use authorization systems is that known mechanisms exist for circumventing the aforementioned security barriers. For example, it is known to circumvent the system by the fact that an unauthorized person closely follows the authorized user who leaves the vehicle that he has just parked, while a second unauthorized person remains near to the vehicle. The first and the second unauthorized persons each carry radio signal transmission means to increase the signal transmission range between the authentication means and the control apparatus in such a way that the encoded signal transmitted by the control apparatus is guided by the radio signal transmission means to the authentication means of the authorized user and the signal newly encoded by the authentication means is returned to the control apparatus by the radio signal transmission means without the user being near to the vehicle or noticing anything. The vehicle is then unlocked without the true code having to be known to the unauthorized persons. The second unauthorized person then has access to the vehicle. An attack of this type is normally known as a “Relay Station Attack (RSA)”.

The object of the present invention is to obtain a portable authentication means and a vehicle security system for a motor vehicle which offers increased security against abuse and, in particular, effectively reduces the possibility of a relay station attack.

This object is achieved by a portable authentication means, notably for use with a motor vehicle, the authentication means including a transmit unit and a receive unit for wireless signal transmission between the authentication means and a control apparatus built into the motor vehicle for the access authorization control and/or use authorization for a motor vehicle, in which the authentication means furthermore has an encoding and decoding unit for decoding the received signals and for encoding the transmitted signals, the authentication means including an inertial detector and/or a movement detector.

This object is also achieved by a portable authentication means which has a transmit unit and a receive unit for wireless signal transmission with a control unit built into a vehicle to control the access authorization and/or use authorization for the vehicle, in which the authentication means furthermore has an encoding and decoding unit for decoding the received signals and for encoding the transmitted signals, in which the authentication means furthermore has an inertial detector and/or a movement detector.

It is advantageously possible to carry out a measurement by means of the inertial detector and/or the movement detector in order to ascertain whether the authentication means is moving. In this way, it is possible to check whether the authorized user, who is carrying the authentication means, is moving during the access and/or use authorization check (referred to below as the “authorization check”). If a movement of the user is detected during the authorization check, it must be considered that a relay station attack is in progress, since the user, who is located outside his vehicle in order to be able to access the vehicle, has normally stopped moving. In the same way, an authorized user carrying the authentication means who would like to start the engine and who needs to disengage the immobilizer should have stopped moving because he is seated on the driver's seat (or a bag containing the authentication means should be motionless in the vehicle). The use authorization check is preferably interrupted when a movement of the authentication means is detected via the inertial detector and/or the movement detector. It is conceivable for the authentication means not to send a (newly encoded) signal to the control apparatus when a movement is detected, or for the movement information to be transmitted from the authentication means to the control apparatus and for the control apparatus to interrupt the use authorization check when the movement information indicates a movement of the authentication means. It is conceivable here for a comparison with a threshold value to be carried out.

According to the present invention, it is preferred that the inertial detector and/or the movement detector includes an acceleration sensor and/or a rotational speed sensor.

According to one variant of the present invention, it is preferred that the inertial detector and/or the movement detector includes a sensor to recognize a change of position of the authentication means.

With an acceleration sensor and/or a rotational speed sensor and/or a sensor for recognizing a change of position of the authentication means, it is advantageously possible according to the present invention that the position or the movement status of the user carrying the authentication means can be determined precisely and at moderate cost.

Moreover, it is preferred according to the present invention that the inertial detector and/or the movement detector generates a signal which is transmitted to the control apparatus.

Via an implementation of this type, it is advantageously possible according to the present invention that the movement status of the authentication means can be taken into consideration by the control apparatus.

Another subject-matter of the present invention is a vehicle security system for a motor vehicle which includes the control apparatus built into the vehicle and the described portable authentication means which is configured for wireless signal transmission with the control apparatus for the performance of the access authorization and/or use authorization control for the vehicle.

Another subject-matter of the present invention is a method for controlling the access authorization and/or use authorization for a vehicle, in which, in a first step, a first encoded signal is transmitted wirelessly from the control apparatus built into the vehicle to the portable authentication means in which, in a second step, a second encoded signal is transmitted wirelessly from the authentication means to the control apparatus, in which the control apparatus compares the first signal and the second signal with one another and, on the basis of the comparison, permits or prevents access to the vehicle and or use of the vehicle, in which, moreover, access to the vehicle and or use of the vehicle is permitted or prevented on the basis of information relating to the movement of the authentication means. The movement information is preferably produced by an inertial detector and/or a movement detector built into the authentication means. The movement information is further preferably transmitted wirelessly to the control apparatus.

According to one preferred embodiment of the present invention, the inertial detector includes an acceleration sensor and/or a rotational speed sensor. The movement detector preferably includes a sensor for recognizing a change of position, for example a GPS sensor, and/or a magnetic field detector, for example an electronic compass.

According to one preferred embodiment, the vehicle security system has a position recognition unit which is configured to recognize the movement of the authentication means using field measurements. The intensity of the field of the second signal sent by the authentication means is measured here and compared with a preceding signal and/or with a threshold value. A comparison of the second signal with second signals received previously in time advantageously permits the building of a movement profile of the authentication means. To permit the use of the vehicle (the engine starts up, the immobilizer is disengaged), it is preferably provided that the movement profile of the authentication means is observed between the vehicle access authorization (unlocking of the doors) and the engine start-up command. The use of the vehicle is, in particular, authorized only when the movement profile essentially corresponds to a typical change of position of the user or a bag from the position outside the vehicle outside the driver's door to the inside of the vehicle. The movement information of the inertial detector and/or the movement detector is also preferably used to determine the actual movement profile. In this way, it is ensured that a departure with the vehicle is possible only when the authentication means describes a typical movement for the step of a vehicle driver getting into a vehicle.

Other details, characteristics and advantages of the invention will be evident from the drawings, and also from the description which follows of preferred embodiments shown in the drawings. Here, the drawings only illustrate example embodiments of the invention, which do not limit the essential inventive idea.

### BRIEF DESCRIPTION OF THE DRAWINGS

The invention will be better understood from the following description which relates to preferred embodiments, given as non-limiting examples and explained with reference to the attached schematic drawing, in which:

FIG. 1 shows schematically the vehicle security system according to the embodiment of the present invention, in the presence of an RSA attack (relay station attack), and

FIG. 2 shows schematically a perspective view of a contact according to the prior art.

### DESCRIPTION OF THE DRAWINGS

Example embodiments of the invention are explained in more detail below with reference to drawings.

In all the drawings, corresponding parts are indicated by the same references.

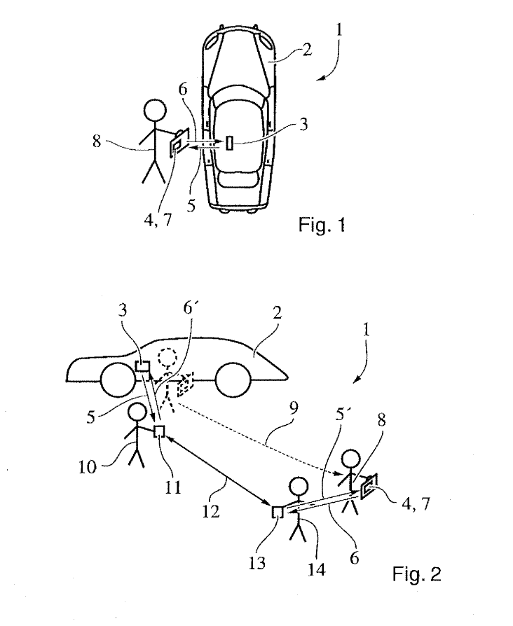

FIG. 1 shows a vehicle security system 1 and an authentication means 4 according to one example embodiment of the present invention. The vehicle security system 1 includes a control apparatus 3 installed in a vehicle 2 and a portable authentication means 4. The authentication means 4 is carried by the user 8 of the vehicle 2 and serves to release a keyless access to the vehicle 2 and to cause the engine of the vehicle 2 to start up keylessly, i.e. by pressing a start button. The keyless notion means that the user 8 does not have to manually actuate any key in order to gain access to the vehicle 2, and also that he does not have to engage the key in the start-up contact to cause the engine to start up, and to use the vehicle 2. The control apparatus 3 is coupled to antennas (not shown) in order to send a first encoded signal 5 to an authentication means 4 located in the near surrounding field (also referred to as the operational area) of the vehicle 2 in order to perform an access authorization and use authorization control procedure. The first signal 5 is transmitted, for example, at periodic time intervals and/or when the external handle of a vehicle door of the vehicle 2 is touched and/or when the arrival of a person near to the vehicle 2 is detected. An authentication means 4 located in the surrounding field of the vehicle 2 receives the first signal 5, decodes the first signal 5 and returns it with a new encoding in the form of a second encoded signal 6. The control apparatus 3 receives the second signal 6. The two encoding algorithms are stored in the control apparatus 3 in such a way that the second signal 6 can be decoded by the control apparatus 3. After the decoding, the second decoded signal 6 is compared with the first decoded signal 5. If a match is detected, it is ensured that the “correct”, i.e. authorized, authentication means 4 is involved. An authentication is effected in such a way that access to the vehicle 2 is granted to the user 8, i.e. that the door locks are unlocked and/or a start-up of the engine of the vehicle 2 by the user 8 is authorized, i.e. the immobilizer is de-activated.

The authentication means 4 according to the invention furthermore has an inertial detector 7 intended to prevent abuse. The inertial detector 7 detects acceleration forces acting on the authentication means 4 which are due to a movement of the authentication means 4. The corresponding acceleration signals are transmitted to the control apparatus 3 at the same time as the second signal 6. The control apparatus 3 is configured in such a way that the authentication is effected only if the authentication means 4 has stopped moving during the access authorization and/or use authorization control procedure. In this way, it is ensured that the user 8 is actually standing outside the vehicle 2 when the access is released, and/or that the authentication means 4 is actually inside the vehicle 2 when a start-up of the engine is released.

Optionally, the vehicle security system 1 has a position recognition unit which is configured to recognize the movement of the authentication means 4 using field measurements. The field intensity of the second signal 6 sent by the authentication means 4 is measured here and compared with preceding signals and/or with a threshold value. A comparison of the second signal 6 with second signals received previously in time enables the building of a movement profile of the authentication means 4. This movement profile may optionally be optimized by using the acceleration signals from the inertial detector 7. A movement profile of the authentication means 4 is produced between the access authorization and the request to start up the engine (pressing the start button) by the user 8. Using this movement profile, it is possible to evaluate whether the movement profile is typical of a movement of the user 8 between the time when he is standing outside the door of the vehicle and the time when he sits down on the vehicle seat. It is of course conceivable to check whether the movement profile is typical of a bag in which the use means 4 has been placed and which is set down by the user 8 in the vehicle 2, for example on the rear seat or in the trunk. The immobilizer of the vehicle 2 is then disengaged only when such a typical movement profile is detected. When the authentication means 4 moves, for example, uniformly and at high speed between the access authorization and the request to start up the engine, this indicates that an attempt at abuse is in progress, for example a relay station attack (explained in more detail with reference to FIG. 2). A typical movement profile is not present and the immobilizer remains activated.

It is conceivable that, in order to optimize a movement profile, the authentication means furthermore has a sensor for recognizing a change of position, for example a GPS sensor, and/or a magnetic field detector. The inertial detector 7 includes, in particular, an acceleration sensor.

FIG. 2 shows the vehicle security system 1 according to the example embodiment of the present invention explained with reference to FIG. 1, in the presence of an RSA attack (relay station attack). The authorized user 8 parks his vehicle 2 and moves away from his vehicle 2 along the road 9. A first unauthorized person now approaches the vehicle 2 and triggers the transmission of the first signal 5 by the control apparatus 3. The authorized user 8, who is carrying the authentication means 4, is already located so far away from the vehicle 2 that the first signal 5 with a severely limited range no longer reaches the authentication means 4. However, the first unauthorized person 10 is carrying a first radio signal transmission means 11 which transmits the first signal 5 over a long range 12 to a second corresponding radio signal transmission means 13. The second radio signal transmission means 13 is being carried by a second unauthorized person 14 who discreetly follows the authorized user 8. The second radio signal transmission means 13 sends the first retransmitted signal 5′ in such a way that it arrives in the receive area of the authentication means 4. The authentication means 4 then transmits the second signal 6, which is sent via the second radio signal transmission means 13 and the first radio signal transmission means 11 to the control apparatus 3 in the form of the second retransmitted signal 6′. A vehicle security system 1 known from the prior art would now release access to the vehicle 2. With the present vehicle security system 1, the movement information from the inertial detector 7 built into the authentication means 4 is, however, sent at the same time as the second signal 6. An evaluation of the movement information now indicates to the control apparatus 3 that the authentication means 4 is moving quickly. Access is consequently prevented, since the authentication means 4 has a movement profile atypical of the user 8 who is carrying the authentication means 4 and wishes to access his vehicle 2. It is optionally conceivable for the movement information to be evaluated only when the engine is to be started up. In the present instance, the movement between the access authorization and the request to start up the engine is evaluated. If the authentication means 4 describes a fast and continuous movement here, the immobilizer is not deactivated, since the movement profile is atypical. It is optionally conceivable for the vehicle security system 1 to have a position recognition unit which is configured to recognize the movement of the authentication means 4 using field measurements. In the present instance, the field intensity of the second signal 6 sent by the authentication means 4 is measured and compared with preceding signals and/or with a threshold value. A comparison of the second signal 6 with signals received previously in time enables the building of a more precise movement profile of the authentication means 4.

### LIST OF REFERENCE NUMBERS

1 vehicle security system

2 vehicle

3 control apparatus

4 authentication means

5 first signal

5′ first retransmitted signal

6 second signal

6′ second retransmitted signal

7 inertial detector

8 user

9 road

10 first unauthorized person

11 first radio signal transmission means

12 range

13 second radio signal transmission means

14 second unauthorized person

1. A portable authentication apparatus for use with a motor vehicle comprising:
a transmit unit and a receive unit for wireless signal transmission between the authentication apparatus and a control apparatus built into the motor vehicle to control the access authorization and/or use authorization for the motor vehicle;
wherein an encoding and decoding unit for decoding the received signals and for encoding the transmitted signals; and
an inertial detector and/or a movement detector.

2. The authentication apparatus as claimed in claim 1, wherein the inertial detector and/or the movement detector includes an acceleration sensor and/or a rotational speed sensor.

3. The authentication apparatus as claimed in claim 1, wherein the inertial detector and/or the movement detector includes a sensor to recognize a change of position of the authentication apparatus.

4. The authentication apparatus as claimed in claim 1, wherein the inertial detector and/or the movement detector generates a signal which is transmitted to the control apparatus.

5. A vehicle security system, comprising:
a control apparatus built into a motor vehicle to control the access authorization and/or use authorization for the motor vehicle; and
a portable authentication apparatus, the authentication apparatus including a transmit unit and a receive unit for wireless signal transmission between the authentication apparatus, and the control apparatus, the authentication apparatus having an encoding and decoding unit for decoding the received signals and for encoding the transmitted signals, wherein the authentication apparatus includes an inertial detector and/or a movement detector.

6. The vehicle security system as claimed in claim 5, wherein the inertial detector and/or the movement detector includes an acceleration sensor and/or a rotational speed sensor.

7. The vehicle security system as claimed in claim 5, wherein the inertial detector and/or the movement detector includes a sensor to recognize a change of position of the authentication apparatus.
